(19) United States
(12) Patent Application Publication
(10) Pub. No.: US 2021/0223793 A1
(43) Pub. Date: Jul. 22, 2021

(54) CONTROL METHOD AND DEVICE FOR MOBILE PLATFORM, AND MOBILE PLATFORM

(71) Applicant: SZ DJI TECHNOLOGY CO., LTD., Shenzhen (CN)

(72) Inventors: Yuanyuan TIAN, Shenzhen (CN); Chengwei ZHU, Shenzhen (CN)

(73) Assignee: SZ DJI TECHNOLOGY CO., LTD., Shenzhen (CN)

(21) Appl. No.: 17/221,846

(22) Filed: Apr. 5, 2021

Related U.S. Application Data
(63) Continuation of application No. PCT/CN2019/080584, filed on Mar. 29, 2019.

(51) Int. Cl. G05D 1/10; B64C 39/02; G05D 1/00

(52) U.S. Cl. CPC G05D 1/101; B64C 2201/146; G05D 1/0094; B64C 39/024

(57) ABSTRACT

Embodiments of the present disclosure provide a mobile platform control method and device, and a mobile platform. The method includes: obtaining motion control area information of a mobile platform; and controlling motion of the mobile platform based on the motion control area information, to restrict motion of the mobile platform in a motion control area indicated by the motion control area information. In this way, automatic and intelligent motion control is implemented on the mobile platform, problems of the mobile platform moving out of a safe area or even crashing due to an improper operation of a user can be avoided, the safety of the mobile platform in the moving process is improved, and user experience is improved.

### RELATED APPLICATIONS

This application is a continuation application of PCT application No. PCT/CN2019/080584, filed on Mar. 29, 2019, and the content of which is incorporated herein by reference in its entirety.

### TECHNICAL FIELD

The present disclosure relates to the field of control technologies, and in particular, to a mobile platform control method and device, and a mobile platform.

### BACKGROUND

Currently, when a mobile platform, such as an unmanned aerial vehicle or an unmanned ship moves indoors or in an area with poor global positioning system (GPS) signal, the mobile platform is usually controlled depending on a user's professional control skills, controlled by using an erected physical fence in combination with an autonomous obstacle avoidance function of the mobile platform, or controlled depending on a large-range electronic fence defined by a GPS device.

However, since professional control skills are required for a user, and user experience may be poor. In addition, it is difficult to realize the function of a small-range electronic fence due to the fact that GPS information usually has relatively large errors. Moreover, the autonomous obstacle avoidance function requires omnidirectional obstacle avoidance, which may result in excessively high technical costs. In view of the foregoing, how to improve the safety of mobile platforms moving within a small area has become a focus of research.

### BRIEF SUMMARY

Embodiments of the present disclosure provide a method and a device for controlling a mobile platform, and a mobile platform to implement intelligent and automatic control on the mobile platform, and improve the safety of the mobile platform in a moving process.

According to a first aspect, some exemplary embodiments of the present disclosure provide a mobile platform control method, including: obtaining motion control area information of a mobile platform; and controlling motion of the mobile platform based on the motion control area information, to restrict the motion of the mobile platform in a motion control area associated with the motion control area information.

According to a second aspect, some exemplary embodiments of the present disclosure provide a control device, including: at least one storage medium storing a set of instructions for controlling a mobile platform; and at least one processor in communication with the at least one storage medium, where during operation, the at least one processor executes the set of instructions to obtain motion control area information of a mobile platform, and control motion of the mobile platform based on the motion control area information, to restrict the motion of the mobile platform in a motion control area indicated by the motion control area information.

According to a third aspect, some exemplary embodiments of the present disclosure provide a mobile platform, including: a body; a power system, disposed on the body and configured to provide a moving power; and a processor, configured to obtain motion control area information, and control the mobile platform to move, based on the motion control area information, in a motion control area indicated by the motion control area information.

In the embodiments of the present disclosure, the control device obtains the motion control area information of the mobile platform, and controls the motion of the mobile platform based on the motion control area information to restrict the motion of the mobile platform in the motion control area indicated by the motion control area information, thereby implementing automatic and intelligent control on the mobile platform and improving the safety of the mobile platform in the moving process.

### BRIEF DESCRIPTION OF THE DRAWINGS

To clearly describe the technical solutions in the embodiments of the present disclosure, the following briefly describes the accompanying drawings required for describing the embodiments. Apparently, the accompanying drawings in the following description merely show some exemplary embodiments of the present disclosure, and a person of ordinary skill in the art may still derive other drawings from these accompanying drawings without creative efforts.

FIG. 1 is a schematic structural diagram of a control system according to some exemplary embodiments of the present disclosure;

FIG. 2 is a schematic flowchart of a mobile platform control method according to some exemplary embodiments of the present disclosure;

FIG. 3 is a schematic interface diagram of a motion control area according to some exemplary embodiments of the present disclosure;

FIG. 4 is a schematic interface diagram of another motion control area according to some exemplary embodiments of the present disclosure;

FIG. 5 is a schematic interface diagram of still another motion control area according to some exemplary embodiments of the present disclosure;

FIG. 6 is a schematic interface diagram of still another motion control area according to some exemplary embodiments of the present disclosure;

FIG. 7 is a schematic interface diagram of still another motion control area according to some exemplary embodiments of the present disclosure;

FIG. 8 is a schematic interface diagram of still another motion control area according to some exemplary embodiments of the present disclosure;

and

FIG. 9 is a schematic structural diagram of a control device according to some exemplary embodiments of the present disclosure.

### DETAILED DESCRIPTION

The following clearly describes the technical solutions in some exemplary embodiments of the present disclosure with reference to the accompanying drawings. Apparently, the described exemplary embodiments are merely some but not all of the embodiments of the present disclosure. All other embodiments obtained by a person of ordinary skill in the art based on the embodiments of the present disclosure without creative efforts shall fall within the scope of protection of the present disclosure.

The following describes in detail some exemplary embodiments of the present disclosure with reference to the accompanying drawings. In absence of conflicts, the following embodiments and features in the embodiments may be combined.

A mobile platform control method provided by some exemplary embodiments of the present disclosure may be performed by a control system. The control system may include a remote control device, a control device, and a mobile platform. In some exemplary embodiments, the remote control device may establish a communication with the control device, and a bidirectional communication may be established between the control device and the mobile platform for bidirectional communication. In some exemplary embodiments, the control device may be a component of the mobile platform, that is, the mobile platform includes the control device. In some exemplary embodiments, the control device may be spatially independent of the mobile platform. In some exemplary embodiments, the control device may be applied to the mobile platform. In some exemplary embodiments, the mobile platform may include, but is not limited to, a mobile device such as an unmanned aerial vehicle, an unmanned vehicle, an unmanned ship, or a robot that can move autonomously. In the control system provided by some exemplary embodiments of the present disclosure, the control device may obtain motion control area information of the mobile platform, and control the motion of the mobile platform based on the motion control area information, so as to restrict the motion of the mobile platform within a motion control area indicated by the motion control area information.

In some exemplary embodiments, the control system provided by some exemplary embodiments of the present disclosure may set the motion control area information of the mobile platform by using the remote control device, and send control amount information and the motion control area information (e.g., joystick operation amount information) generated by the remote control device to the control device by using the remote control device. In a scenario that satisfies illuminance and texture requirements, the mobile platform may obtain status information of the mobile platform by using a visual-inertial odometry technology or the like, and send the status information of the mobile platform to the control device. The control device may determine virtual control amount information based on the control amount information, the motion control area information, and the status information of the mobile platform. The control device may control the motion of the mobile platform based on the virtual control amount information, to restrict the motion of the mobile platform within the motion control area indicated by the motion control area information.

In some exemplary embodiments, the motion control area information of the mobile platform may be preset in the mobile platform. In this case, the control device does not need to obtain the motion control area information by using the remote control device, but may directly obtain the preset motion control area information of the mobile platform, and controls the motion of the mobile platform based on the motion control area information, to restrict the motion of the mobile platform within the motion control area indicated by the motion control area information.

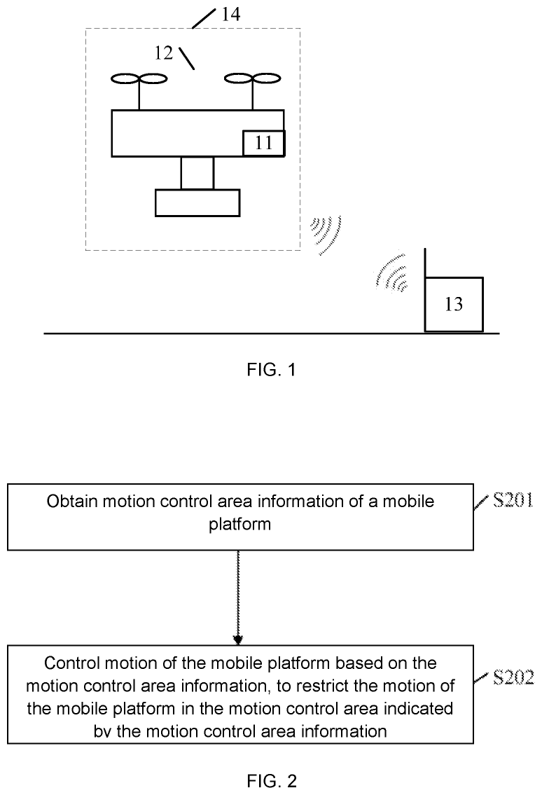

Specifically, FIG. 1 is a schematic structural diagram of a control system according to some exemplary embodiments of the present disclosure. The control system shown in FIG. 1 includes a control device 11, a mobile platform 12, and a remote control device 13. In some exemplary embodiments, the remote control device 13 may be a control terminal of the mobile platform 12. In some exemplary embodiments, the remote control device 13 may include, but is not limited to, any one or more of a remote control, a smartphone, a tablet computer, a laptop computer, a ground station, and a wearable device (a watch or a wristband). In some exemplary embodiments, the control device 11 is disposed on the mobile platform 12. In some exemplary embodiments, the control device 11 may be any one or more of a smartphone, a tablet computer, a laptop computer, and the like. In some exemplary embodiments, the mobile platform 12 may include, but is not limited to, a mobile device such as an unmanned aerial vehicle, an unmanned vehicle, or an unmanned ship. The mobile platform 12 may include a power system, where the power system is configured to provide power for the mobile platform to move.

In some exemplary embodiments of the present disclosure, the control device 11 may obtain control amount information generated by the remote control device 13 and sent it to the mobile platform 12. A user may set motion control area information of the mobile platform 12 through a user interface of the remote control device 13 or an application (Application, APP) on a user interface, and send the motion control area information to the control device 11. The mobile platform 12 may obtain status information of the mobile platform 12 in real time, and send the status information to the control device 11. The control device 11 may calculate virtual control amount information based on the obtained control amount information, the motion control area information, and the status information of the mobile platform, and control, based on the virtual control amount information, the motion of the mobile platform 12 within a motion control area 14 indicated by the motion control area information. This implementation can avoid that the mobile platform moves out of the motion control area indicated by the motion control area information due to an improper operation of the user.

With reference to accompanying drawings, the following exemplarily describes a mobile platform control method provided by some exemplary embodiments of the present disclosure.

FIG. 2 is a schematic flowchart of a mobile platform control method according to some exemplary embodiments of the present disclosure. The method may be performed by a control device. Detailed descriptions for the control device are the same as above, and will not be provided again herein. Specifically, the method in some exemplary embodiments of the present disclosure includes the following steps.

S201. Obtain motion control area information of a mobile platform.

In some exemplary embodiments of the present disclosure, the control device may obtain the motion control area information of the mobile platform. In some exemplary embodiments, the motion control area information may be obtained by a user by setting a motion control area, generating the motion control area information based on the set motion control area, and sending the generated motion control area information to the control device through a remote control device. In some exemplary embodiments, the motion control area information may be fixedly set in the mobile platform beforehand.

In some exemplary embodiments, the motion control area information of the mobile platform may include location information of a geometric center of the motion control area. In some exemplary embodiments, the motion control area may include, but is not limited to, an enclosed area of a shape such as a circular area, a rectangular area, or a square area. In some exemplary embodiments, the geometric center may include, but is not limited to, a geometric center of any shape, such as a center of a circular area, a center of a rectangular area, or a center of a square area.

In some exemplary embodiments, the motion control area may be a circular area, and the motion control area information includes a radius of the circular area; the geometric center may include a center, and the motion control area information may include location information of the center of the circular area.

In some exemplary embodiments, the geometric center includes a center, where the center may include a specified location point that is preset on the remote control device, and the radius may include a specified distance that is preset on the remote control device. The motion control area may include a circular area that is determined by using the preset specified location point as a center and the preset specified distance as a radius.

Taking an unmanned aerial vehicle as an example, a user may preset a specified location point as a center and a specified distance as a radius on the remote control device. In a flight process of the unmanned aerial vehicle, the remote control device may send information of a circular area that is determined by using the preset specified location point as a center and the preset specified distance as a radius to the control device, so that the control device determines the circular area as a flight control area of the unmanned aerial vehicle.

In some exemplary embodiments, the geometric center may include, but is not limited to, at least one of a location point at which the mobile platform starts moving, a current location point of the mobile platform, and a location point of the remote control device.

In some exemplary embodiments, when obtaining the motion control area information of the mobile platform, the control device may obtain a radius of the motion control area that is sent by the remote control device. In some exemplary embodiments, the radius may be determined when the remote control device detects a radius-selection operation of the user.

In some exemplary embodiments, the geometric center may include a center, where the center may be a location point at which the mobile platform starts moving, and the radius may be determined based on a radius-selection operation received on a user interface of the remote control device in a moving process of the mobile platform. In some exemplary embodiments, the radius-selection operation may be a tapping operation of the user on the user interface of the remote control device. In some exemplary embodiments, the radius-selection operation may be a radius setting operation of the user by using a key on the remote control device. In some exemplary embodiments, the radius-selection operation may be another operation of determining the radius, and is not specifically limited in the present disclosure.

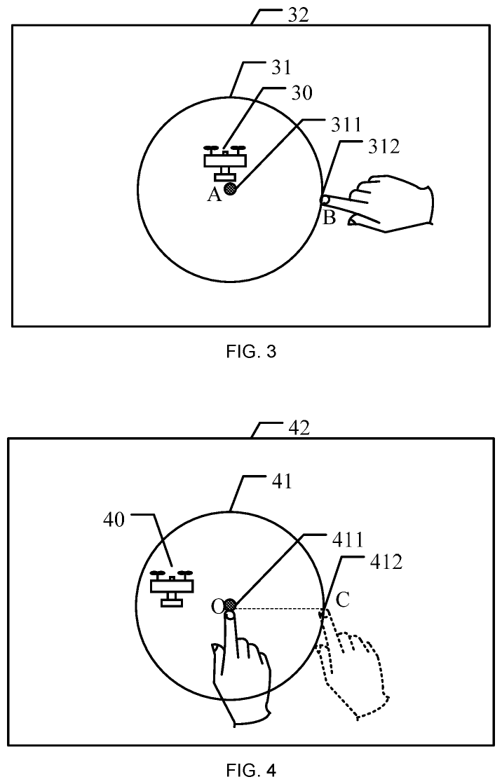

Taking the unmanned aerial vehicle shown in FIG. 3 as an example, FIG. 3 is a schematic interface diagram of a motion control area according to some exemplary embodiments of the present disclosure. As shown in FIG. 3, when the unmanned aerial vehicle 30 takes off at a takeoff location point A 311, the point A 311 may be determined as a center. The user may tap by using the point A 311 on a map 32 on the user interface of the remote control device as a start point and slide to a point B 312, and then stop. In this case, a distance between the point A 311 and the point B 312 may be determined as a radius, and a flight control area of the unmanned aerial vehicle 30 is determined as a circular area 31 based on the center A 311 and the radius.

In some exemplary embodiments, when obtaining the motion control area information of the mobile platform, the control device may obtain location information of the geometric center of the motion control area that is sent by the remote control device. In some exemplary embodiments, the location information of the geometric center may be determined when the remote control device detects a center-selection operation of the user.

In some exemplary embodiments, the geometric center may be a center, where the center may be determined based on a center-selection operation of the user that is detected on a map on the user interface of the remote control device. In some exemplary embodiments, the radius may be determined based on a radius-selection operation received on the user interface of the remote control device in a moving process of the mobile platform. In some exemplary embodiments, the center-selection operation includes, but is not limited to, any one or more of a tapping operation, a sliding operation, a dragging operation, and the like.

Taking the unmanned aerial vehicle shown in FIG. 4 as an example, FIG. 4 is a schematic interface diagram of another motion control area according to some exemplary embodiments of the present disclosure. As shown in FIG. 4, after the unmanned aerial vehicle 40 takes off, the user may tap a point O 411 on a map 42 on the user interface of the remote control device, and therefore the point O 411 is determined as a center. The user then performs a sliding operation by using the point O 411 as a start point and slides to a point C 412, and then stops. In this case, a sliding distance between the point O 411 and the point C 412 may be determined as a radius. Therefore, by using the point O 411 as a center and the sliding distance between the point O 411 and the point C 412 as a radius, a flight control area of the unmanned aerial vehicle 40 is determined as a circular area 41.

In some exemplary embodiments, the motion control area of the mobile platform may move in a moving process of the mobile platform. In some exemplary embodiments, the motion control area may move based on an area motion operation obtained on the remote control device. In some exemplary embodiments, in a moving process of the motion control area, the mobile platform is always in the motion control area. In some exemplary embodiments, the area motion operation includes any one or more of a tapping operation, a dragging operation, and a control operation.

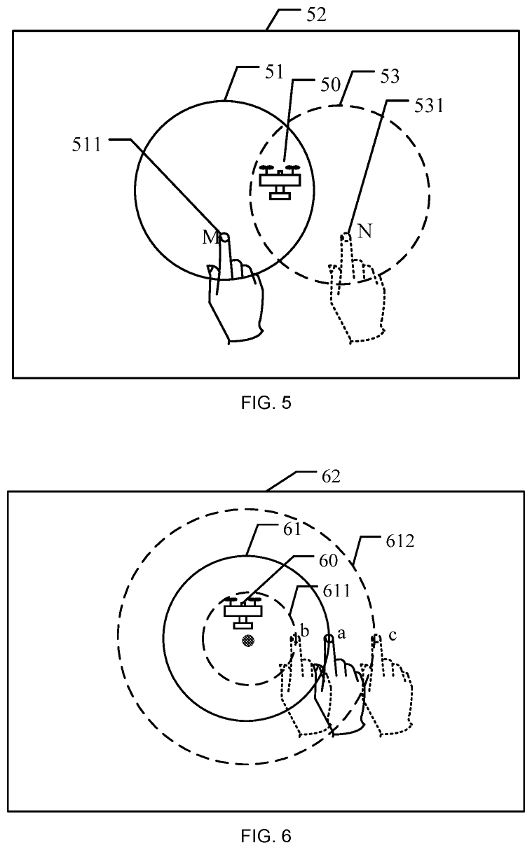

Taking the unmanned aerial vehicle shown in FIG. 5 as an example, FIG. 5 is a schematic interface diagram of still another motion control area according to some exemplary embodiments of the present disclosure. As shown in FIG. 5, assuming that the circular area 51 is a flight control area of the unmanned aerial vehicle 50, in a process in which the unmanned aerial vehicle 50 flies in the circular area 51, the user may tap a point M 511 in the circular area 51 displayed on a map 52 on the user interface of the remote control device and drag the point M to a point N 531, and drag the circular area 51 to a position in which a circular area 53 is located. The unmanned aerial vehicle 50 is in the circular areas 51 and 53 before and after the dragging.

In another example, assuming that the remote control device includes up, down, left, and right keys for controlling the motion of a flight control area of the unmanned aerial vehicle, the user may tap any one or more of the up, down, left, and right keys in a process in which the unmanned aerial vehicle flies in the flight control area, to control the motion of the flight control area.

In some exemplary embodiments, a size of the motion control area of the mobile platform may be changed in a moving process of the mobile platform. In some exemplary embodiments, the size of the motion control area may be changed based on a size change operation of the motion control area displayed on the map on the user interface of the remote control device. In some exemplary embodiments, the size change operation includes, but is not limited to, an operation of tapping and dragging a boundary line of the motion control area.

Taking the unmanned aerial vehicle shown in FIG. 6 as an example, FIG. 6 is a schematic interface diagram of still another motion control area according to some exemplary embodiments of the present disclosure. As shown in FIG. 6, assuming that a current flight control area of the unmanned aerial vehicle 60 is a circular area 61, in a process in which the unmanned aerial vehicle 60 flies in the circular area 61, under a condition of ensuring that the unmanned aerial vehicle 60 flies in the circular area 61, the user may tap a point a on a boundary line of the circular area 61 displayed on a map 62 on the user interface of the remote control device and then drag with the center unchanged. If the point a is dragged to a point b in the circular area 61, the circular area 61 may be reduced to obtain a circular area 611. If the point a is dragged to a point c outside the circular area 61, the circular area 61 may be increased to obtain a circular area 612.

In some exemplary embodiments, the motion control area of the mobile platform may be obtained in a moving process of the mobile platform based on an area selection operation received on the map on the user interface of the remote control device.

In some exemplary embodiments, when obtaining the motion control area information of the mobile platform, the control device may obtain location information of a boundary point of the motion control area that is sent by the remote control device. In some exemplary embodiments, the location information of the boundary point may be determined when the remote control device detects a boundary-point-selection operation of the user on the user interface of the remote control device, where the user interface displays a map around the mobile platform. In some exemplary embodiments, the boundary-point-selection operation may include a tapping operation on the boundary point received on the map on the user interface of the remote control device. In some exemplary embodiments, the motion control area may include an area enclosed by at least three boundary lines, where each boundary line is obtained by connecting two boundary points.

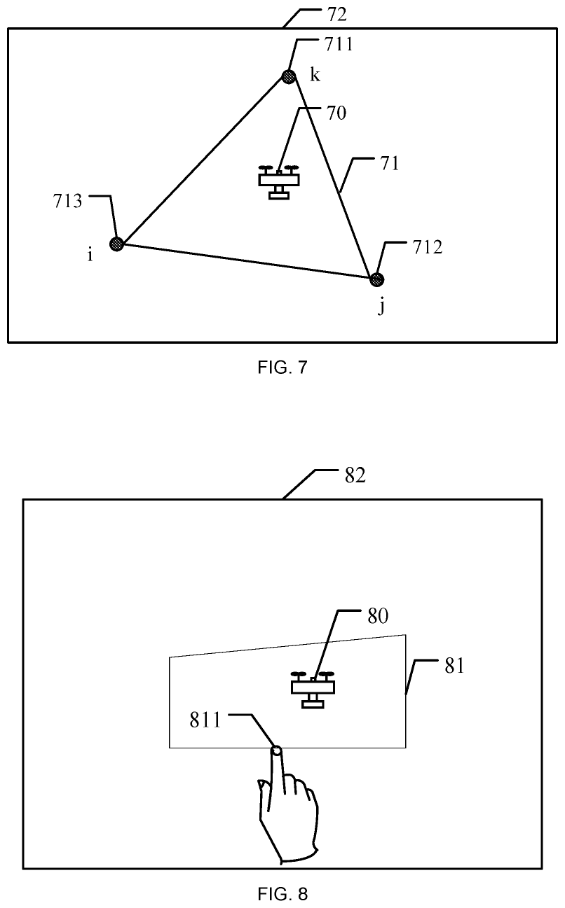

Taking the unmanned aerial vehicle shown in FIG. 7 as an example, FIG. 7 is a schematic interface diagram of still another motion control area according to some exemplary embodiments of the present disclosure. As shown in FIG. 7, after the unmanned aerial vehicle 70 takes off, the user may manually select three points by tapping: a point i 713, a point j 712, and a point k 711 as boundary points on a map 72 displayed on the user interface of the remote control device. In this case, a triangular area 71 may be enclosed by boundary lines obtained by connecting the three boundary points including the point i 713, the point j 712, and the point k 711 that are selected by the user through tapping, and the triangular area 71 may be determined as a flight control area of the unmanned aerial vehicle 70.

In some exemplary embodiments, the area selection operation includes a box selection operation; and the motion control area is an enclosed area of any shape that may be determined based on a box selection operation received on the map on the user interface of the remote control device.

Taking the unmanned aerial vehicle shown in FIG. 8 as an example, FIG. 8 is a schematic interface diagram of still another motion control area according to some exemplary embodiments of the present disclosure. As shown in FIG. 8, after the unmanned aerial vehicle 80 takes off, the user may manually draw a desired shape area 81 starting from a point 811 on a map 82 on the user interface of the remote control device, so as to determine that the shape area 81 is a flight control area of the unmanned aerial vehicle 80.

In some exemplary embodiments of the present disclosure, the implementation of determining motion control areas of different shapes by performing different settings or operations on the remote control device may facilitate subsequent control on the motion of the mobile platform in the motion control area.

S202. Control motion of the mobile platform based on the motion control area information, to restrict motion of the mobile platform in the motion control area indicated by the motion control area information.

In some exemplary embodiments of the present disclosure, the control device may control motion of the mobile platform based on the motion control area information, to restrict the motion of the mobile platform in the motion control area indicated by the motion control area information.

In some exemplary embodiments, the control device may obtain status information of the mobile platform, obtain control amount information generated by the remote control device, determine virtual control amount information based on the status information of the mobile platform, the motion control area information, and the control amount information, and control the motion of the mobile platform based on the virtual control amount information.

In some exemplary embodiments, the mobile platform may obtain status information of the mobile platform in real time by using a visual-inertial odometry technology or the like, and then send the obtained status information to the control device. In some exemplary embodiments, the status information of the mobile platform may include any one or more of a location, an attitude angle, and a velocity of the mobile platform. Taking an unmanned aerial vehicle as an example, an attitude angle of the unmanned aerial vehicle may be determined by a yaw angle, a roll angle, and a pitch angle.

In some exemplary embodiments, the status information of the mobile platform may include the location and velocity of the mobile platform; and when determining the virtual control amount information based on the status information of the mobile platform, the motion control area information, and the control amount information, the control device may determine a braking distance (i.e., a deceleration distance) of the mobile platform based on the velocity of the mobile platform, and determine a distance from the mobile platform to a boundary of the motion control area along a velocity direction of the mobile platform based on the location of the mobile platform and the motion control area information; and when the braking distance (i.e., a deceleration distance) is longer than or equal to the distance from the mobile platform to the boundary of the motion control area, the control device may determine the virtual control amount information based on the braking distance, the distance from the mobile platform to the boundary of the motion control area, and the control amount information.

As can be seen, this implementation may control the mobile platform to move based on the virtual control amount information, thereby ensuring that the mobile platform moves in the motion control area, and preventing the mobile platform from moving beyond the motion control area, so that the safety of the mobile platform in the moving process can be improved.

In some exemplary embodiments, the virtual control amount information may include, but is not limited to, amount information in an opposite direction to the control amount information, as long as the virtual control amount information can control the mobile platform not to move out of the motion control area.

In some exemplary embodiments, the control device may send the virtual control amount information to the mobile platform, so that the mobile platform may move based on the virtual control amount information.

In this way of controlling the motion of the mobile platform based on the virtual control amount information, the mobile platform may be controlled to move in the motion control area. No matter how the user operates the remote control device, the mobile platform does not move out of the motion control area, thereby improving the safety of the mobile platform in the moving process.

In some exemplary embodiments of the present disclosure, the control device may obtain the motion control area information of the mobile platform, and control the motion of the mobile platform based on the motion control area information, to restrict the motion of the mobile platform in the motion control area indicated by the motion control area information. In some exemplary embodiments, automatic and intelligent motion control may be implemented on the mobile platform, problems of the mobile platform such as moving out of a safe area or even crashing due to an improper operation of the user can be avoided, the safety of the mobile platform in the moving process is improved, and user experience is improved.

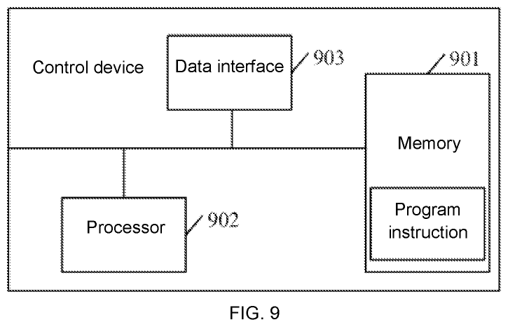

FIG. 9 is a schematic structural diagram of a control device according to some exemplary embodiments of the present disclosure. Specifically, the control device includes one (or more) memory 901, one (or more) processor 902, and one or more data interface 903, and the memory 901 is in communication with the processor 902.

The memory 901 may include a volatile memory. The memory 901 may also include a non-volatile memory. The memory 901 may further include a combination of the foregoing types of memories. The processor 902 may be a central processing unit (CPU). The processor 902 may further include a hardware control device. The hardware control device may be an application-specific integrated circuit (ASIC), a programmable logic device (PLD), or a combination thereof. Specifically, for example, the hardware control device may be a complex programmable logic device (CPLD), a field-programmable gate array (FPGA), or any combination thereof.

Further, the memory 901 may be configured to store a program instruction(s), and the processor 902 may be configured to invoke the program instruction(s) stored in the memory 901 and then perform the method or process set-forth above and/or the following steps when the program instruction(s) is executed:

obtaining motion control area information of a mobile platform; and

controlling motion of the mobile platform based on the motion control area information, to restrict the motion of the mobile platform in a motion control area indicated by the motion control area information.

Further, the motion control area information may include location information of a geometric center of the motion control area.

Further, the motion control area may be a circular area, and the motion control area information may include a radius of the circular area.

Further, the geometric center may include at least one of a location point at which the mobile platform starts moving, a current location point of the mobile platform, and a location point of a remote control device.

Further, when obtaining the motion control area information of the mobile platform, the processor 902 may be specifically configured to:

obtain location information of the geometric center of the motion control area that is sent by a remote control device, where

the location information of the geometric center may be determined when the remote control device detects a center selection operation of a user.

Further, the radius may include a specified distance that is preset.

Further, when obtaining the motion control area information of the mobile platform, the processor 902 may be specifically configured to:

obtain a radius of the motion control area that is sent by a remote control device, where

the radius is determined when the remote control device detects a radius-selection operation of a user.

Further, when obtaining the motion control area information of the mobile platform, the processor 902 may be specifically configured to:

obtain location information of a boundary point of the motion control area that is sent by a remote control device, where

the location information of the boundary point may be determined when the remote control device detects a boundary-point-selection operation of a user on a user interface of the remote control device, where the user interface displays a map around the mobile platform.

Further, the boundary-point-selection operation may include a tapping operation on the boundary point received on the map on the user interface of the remote control device.

Further, when controlling motion of the mobile platform based on the motion control area information, the processor 902 may be specifically configured to:

obtain status information of the mobile platform;

obtain control amount information generated by a remote control device;

determine virtual control amount information based on the status information of the mobile platform, the motion control area information, and the control amount information; and

control motion of the mobile platform based on the virtual control amount information.

Further, the status information of the mobile platform includes any one or more of a location, an attitude angle, and a velocity of the mobile platform.

Further, the status information of the mobile platform may include the location and velocity of the mobile platform; and when determining the virtual control amount information based on the status information of the mobile platform, the motion control area information, and the control amount information, the processor 902 may be specifically configured to:

determine a braking distance of the mobile platform based on the velocity of the mobile platform;

determine a distance from the mobile platform to a boundary of the motion control area along a velocity direction of the mobile platform based on the location of the mobile platform and the motion control area information; and

when the braking distance is longer than or equal to the distance from the mobile platform to the boundary of the motion control area, determine the virtual control amount information based on the braking distance, the distance from the mobile platform to the boundary of the motion control area, and the control amount information.

In some exemplary embodiments of the present disclosure, the control device may obtain the motion control area information of the mobile platform, and control, based on the motion control area information of the mobile platform, the mobile platform to move in the motion area corresponding to the motion control area information. In some exemplary embodiments, automatic and intelligent motion control is implemented on the mobile platform, problems of the mobile platform such as moving out of a safe area and even crashing due to an improper operation of the user can be avoided, the safety of the mobile platform in the moving process is improved, and user experience is improved.

Some exemplary embodiments of the present disclosure further provide a mobile platform, including: a body; a power system, which is disposed on the body and configured to provide power for moving; and a processor configured to obtain motion control area information, and move, based on the motion control area information, in a motion control area indicated by the motion control area information.

Further, the motion control area information may include location information of a geometric center of the motion control area.

Further, the motion control area may be a circular area, and the motion control area information may include a radius of the circular area.

Further, the geometric center may include at least one of a location point at which the mobile platform starts moving, a current location point of the mobile platform, and a location point of a remote control device.

Further, when obtaining the motion control area information of the mobile platform, the processor may be specifically configured to:

obtain location information of the geometric center of the motion control area that is sent by a remote control device, where

the location information of the geometric center may be determined when the remote control device detects a center-selection operation of a user.

Further, the radius may include a specified distance that is preset.

Further, when obtaining the motion control area information of the mobile platform, the processor may be specifically configured to:

obtain a radius of the motion control area that is sent by a remote control device, where

the radius is determined when the remote control device detects a radius-selection operation of a user.

Further, when obtaining the motion control area information of the mobile platform, the processor may be specifically configured to:

obtain location information of a boundary point of the motion control area that is sent by a remote control device, where

the location information of the boundary point is determined when the remote control device detects a boundary-point-selection operation of a user on a user interface of the remote control device, where the user interface displays a map around the mobile platform.

Further, the boundary-point-selection operation may include a tapping operation on the boundary point received on the map on the user interface of the remote control device.

Further, when controlling motion of the mobile platform based on the motion control area information, the processor may be specifically configured to:

obtain status information of the mobile platform;

obtain control amount information generated by a remote control device;

determine virtual control amount information based on the status information of the mobile platform, the motion control area information, and the control amount information; and

control motion of the mobile platform based on the virtual control amount information.

Further, the status information of the mobile platform may include any one or more of a location, an attitude angle, and a velocity of the mobile platform.

Further, the status information of the mobile platform may include the location and velocity of the mobile platform; and when determining the virtual control amount information based on the status information of the mobile platform, the motion control area information, and the control amount information, the processor may be specifically configured to:

determine a braking distance of the mobile platform based on the velocity of the mobile platform;

determine a distance from the mobile platform to a boundary of the motion control area along a velocity direction of the mobile platform based on the location of the mobile platform and the motion control area information; and

when the braking distance is longer than or equal to the distance from the mobile platform to the boundary of the motion control area, determine the virtual control amount information based on the braking distance, the distance from the mobile platform to the boundary of the motion control area, and the control amount information.

In some exemplary embodiments of the present disclosure, the mobile platform may obtain the motion control area information of the mobile platform, and control, based on the motion control area information of the mobile platform, the mobile platform to move in the motion control area indicated by the motion control area information. In some exemplary embodiments, automatic and intelligent motion control is implemented on the mobile platform, problems of the mobile platform such as moving out of a safe area and even crashing due to an improper operation of the user can be avoided, the safety of the mobile platform in the moving process is improved, and user experience is improved.

Some exemplary embodiments of the present disclosure further provide a computer-readable storage medium, where the computer-readable storage medium stores a computer program, and when the computer program is executed by a processor, the control method set forth in the exemplary embodiments corresponding to FIG. 2 of the present disclosure may be implemented, or the control device set forth in the exemplary embodiments corresponding to FIG. 9 of the present disclosure may be implemented. Details will not be described again herein.

The computer-readable storage medium may be an internal storage unit of the device in any one of the foregoing embodiments, for example, a hard disk or a memory of the device. Alternatively, the computer-readable storage medium may be an external storage device of the device, for example, a removable hard disk provided for the device, a smart memory card (SMC), a secure digital (SD) card, or a flash memory card (Flash Card). Further, the computer-readable storage medium may further include an internal storage unit in the device and an external storage device. The computer-readable storage medium may be configured to store the computer program and another program and data required by a terminal. The computer-readable storage medium may be further configured to temporarily store data that is already output or will be output.

What is disclosed above is merely some exemplary embodiments of the present disclosure, and is certainly not intended to limit the scope of protection of the present disclosure. Therefore, equivalent variations made in accordance with the claims of the present disclosure shall fall within the scope of the present disclosure.

What is claimed is:

1. A mobile platform control method, comprising:
obtaining motion control area information of a mobile platform; and
controlling motion of the mobile platform based on the motion control area information, to restrict the motion of the mobile platform in a motion control area associated with the motion control area information.

2. The method according to claim 1, wherein the motion control area information includes location information of a geometric center of the motion control area.

3. The method according to claim 2, wherein the geometric center includes at least one of a location at which the mobile platform starts moving,
a current location of the mobile platform, or
a location of a remote control device.

4. The method according to claim 2, wherein the obtaining of the motion control area information of the mobile platform includes:
obtaining the location information of the geometric center of the motion control area sent by a remote control device,
wherein the location information of the geometric center is determined upon detecting, by the remote control device, a center-selection operation of a user.

5. The method according to claim 1, wherein the motion control area is a circular area, and
the motion control area information includes a radius of the circular area.

6. The method according to claim 5, wherein the radius includes a preset specified distance.

7. The method according to claim 5, wherein the obtaining of the motion control area information of the mobile platform includes:
obtaining a radius of the motion control area sent by a remote control device,
wherein the radius is determined upon detecting, by the remote control device, a radius-selection operation of a user.

8. The method according to claim 1, wherein the obtaining of the motion control area information of the mobile platform includes:
obtaining location information of a boundary point of the motion control area sent by a remote control device,
wherein the location information of the boundary point is determined upon detecting, by the remote control device, a boundary-point-selection operation of a user on a user interface of the remote control device, and the user interface displays a map around the mobile platform.

9. The method according to claim 8, wherein the boundary-point-selection operation includes a tapping operation on the boundary point received on the map on the user interface of the remote control device.

10. The method according to claim 1, wherein the controlling of the motion of the mobile platform based on the motion control area information includes:
obtaining status information of the mobile platform;
obtaining control amount information generated by a remote control device;
determining virtual control amount information based on the status information of the mobile platform, the motion control area information, and the control amount information; and
controlling the motion of the mobile platform based on the virtual control amount information.

11. The method according to claim 10, wherein the status information of the mobile platform includes at least one of
a location,
an attitude angle, or
a velocity of the mobile platform.

12. The method according to claim 11, wherein the status information of the mobile platform includes the location and velocity of the mobile platform; and
the determining of the virtual control amount information includes:
determining a deceleration distance of the mobile platform based on the velocity of the mobile platform,
determining a distance from the mobile platform to a boundary of the motion control area along a velocity direction of the mobile platform based on the location of the mobile platform and the motion control area information, and
when the deceleration distance is longer than or equal to the distance from the mobile platform to the boundary of the motion control area, determining the virtual control amount information based on the deceleration distance, the distance from the mobile platform to the boundary of the motion control area, and the control amount information.

13. A control device, comprising
at least one storage medium storing a set of instructions for controlling a mobile platform; and
at least one processor in communication with the at least one storage medium, wherein during operation, the at least one processor executes the set of instructions to
obtain motion control area information of a mobile platform, and
control motion of the mobile platform based on the motion control area information, to restrict the motion of the mobile platform in a motion control area indicated by the motion control area information.

14. The device according to claim 13, wherein the motion control area is a circular area, and the motion control area information includes a radius of the circular area.

15. The device according to claim 13, wherein the motion control area information includes location information of a geometric center of the motion control area.

16. The device according to claim 15, wherein the geometric center includes at least one of
a location at which the mobile platform starts moving,
a current location of the mobile platform, or
a location of a remote control device.

17. The device according to claim 15, wherein to obtain the motion control area information of the mobile platform, the at least one processor executes the set of instructions to:
obtain the location information of the geometric center of the motion control area sent by a remote control device,
wherein the location information of the geometric center is determined upon detecting, by the remote control device, a center-selection operation of a user.

18. The device according to claim 13, wherein to obtain the motion control area information of the mobile platform, the at least one processor executes the set of instructions to:
obtain location information of a boundary point of the motion control area sent by a remote control device,
wherein the location information of the boundary point is determined upon detecting, by the remote control device, a boundary-point-selection operation of a user on a user interface of the remote control device, and the user interface displays a map around the mobile platform.

19. The device according to claim 13, wherein to control the motion of the mobile platform based on the motion control area information, the at least one processor executes the set of instructions to:
obtain status information of the mobile platform;
obtain control amount information generated by a remote control device;
determine virtual control amount information based on the status information of the mobile platform, the motion control area information, and the control amount information; and
control the motion of the mobile platform based on the virtual control amount information.

20. A mobile platform, comprising:
a body;
a power system, disposed on the body and configured to provide a moving power; and
a processor, configured to obtain motion control area information, and control the mobile platform to move, based on the motion control area information, in a motion control area indicated by the motion control area information.
